(19) United States
(12) Patent Application Publication
(10) Pub. No.: US 2009/0228613 A1
(43) Pub. Date: Sep. 10, 2009

(54) HOST AND METHOD FOR TERMINATING DATA TRANSMISSION

(75) Inventors: XIAO-GANG FANG, Shenzhen City (CN); KIM-YEUNG SIP, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY ( ShenZhen) CO., LTD., Shenzhen City (CN); HON HAI PRECISION INDUSTRY CO., LTD., Tu-Cheng (TW)

(21) Appl. No.: 12/398,977

(22) Filed: Mar. 5, 2009

(30) Foreign Application Priority Data
Mar. 5, 2008 (CN) 200810300473.8

(51) Int. Cl. G06F 3/00

(52) U.S. Cl. 710/16

(57) ABSTRACT

A host includes a housing, one or more connectors, an interface controller, a sensor, a transmission control unit. The one or more connectors are mounted on the housing. The interface controller controls data transmission through the one or more connectors. The sensor is mounted on the housing for detecting a desired object near the sensor, and generates a sensor signal when presence of the desired object is ascertained. The transmission control unit is configured for monitoring the sensor, outputting a window in response to the sensor signal generated by the sensor, and controlling the interface controller to terminate the data transmission through the one or more connectors in response to a user input to the window. A related computer-implemented method for terminating data transmission is also provided.

### BACKGROUND

1. Field of the Disclosure

The present disclosure is related to data transmission, and particularly to a method for terminating data transmission.

2. Description of Related Art

Most peripheral devices are detachably connected to the host. The peripheral devices may be attached to the host via universal serial bus (USB) connectors, 1394 connectors, and other serial and parallel connectors. The host may be, but are not limited to, desktop computers, notebook computers and personal digital assistants. The USB connector is one of the most popular connector because of its excellent performances and its plug-and-play capability. A USB connector includes a USB port and a USB plug detachably coupled to the port. The USB port is often mounted on the host, and the USB plug is often connected to the peripheral device via a cable.

Before a user attempts to detach a USB connector, the user usually needs to alert the operating system of the host because if a user unplugs the connection during data transmission, data loss or damage to the host may occur. However, alerting the operating system is tedious and time consuming, the user may have to go through a predetermined process and/or may have to wait until the operating system finish other tasks.

What is needed, therefore, is a host and method for terminating data transmission between the host and the peripheral device to overcome the described limitations.

### BRIEF DESCRIPTION OF THE DRAWINGS

FIG. 1 is a schematic diagram of one embodiment of a host connected to a peripheral device via connectors thereof.

FIG. 2 is a block diagram of showing partial functional modules of the host in FIG. 1.

FIG. 3 is a window showing functional buttons for terminating data transmission through the connectors and closing the window.

FIG. 4 is a flowchart of a first embodiment of a method for terminating data transmission through the connectors.

FIG. 5 is a flowchart of a second embodiment of a method for terminating data transmission through the connectors.

### DETAILED DESCRIPTION

All of the data-terminating processes described hereinafter may be embodied in, and fully automated via, functional code modules executed by one or more general purpose computers or processors. The code modules may be stored in any type of computer-readable mediums or other storage devices. Some or all of the data-terminating processes may alternatively be embodied in specialized computer hardware or electrical apparatus.

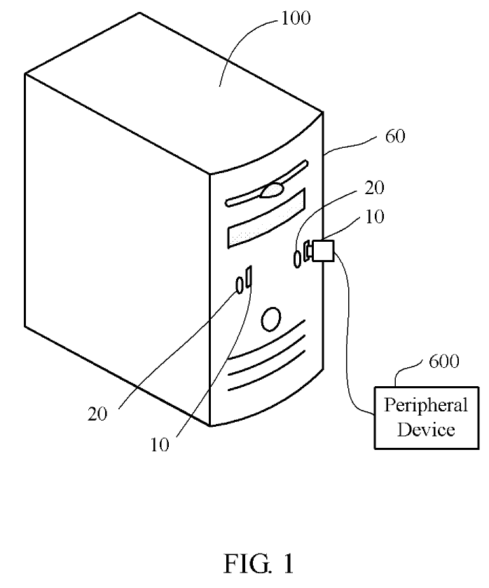

FIG. 1 is a schematic diagram of one embodiment of a host 100 connected to a peripheral device 600 via connectors 10 thereof. The host 100 includes a housing 60 and two connectors 10 mounted on the housing 60. The peripheral device 600 is detachably connected to the host 100 via one of the two connectors 10. The two connectors 10 are, for example, universal serial bus (USB) connectors each of which includes a USB port and a USB plug detachably coupled to the USB port. The USB port is mounted on the housing 60 and the USB plug is connected to the peripheral device 600 via a cable. The host 100 is a desktop computer, but may alternatively be other host with a USB interface.

The host 100 further includes two sensors 20 each of which is for one of the two connectors 10. Each of the two sensors 20 is configured for detecting a desired object near corresponding to one of the two connectors 10, and generating a sensor signal when presence of the desired object is ascertained. The two sensors 20 are set apart from each other at a great distance in order to prevent from inadvertently activating unwanted one of the two sensors 20. As an illustration, each of the two sensors 20 is mounted adjacent to one of the two connectors 10. Thus, when a user stretches out his/her hand to detach the USB plug from the USB port, the sensors 20 may ascertain the desired object (i.e., the hand of the user) and generate the sensor signal. Depending on the embodiments, the two sensors 20 may be, but is not limited to, infrared sensors, ultrasonic sensors, heat sensitive sensors, or touch sensitive sensors.

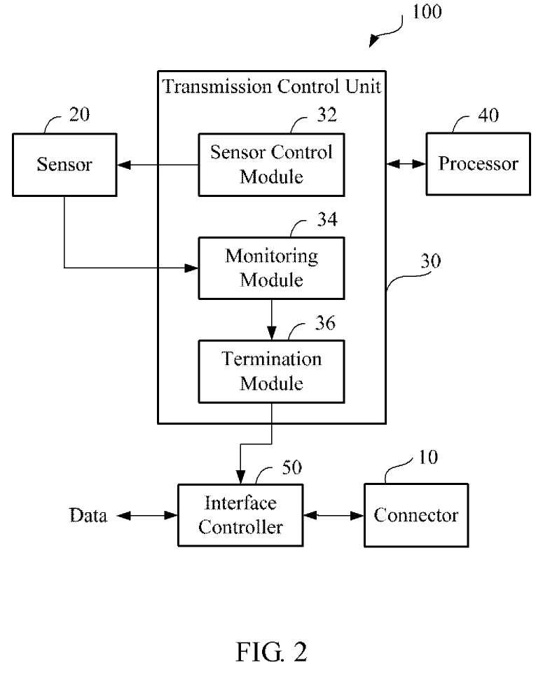

FIG. 2 is a block diagram showing partial functional modules of the host 100 in FIG. 1. The host 100 includes the two connectors 10, the two sensors 20, a transmission control unit 30, a processor 40, and an interface controller 50. The interface controller 50 is used for controlling data transmission through the two connectors 10. The transmission control unit 30 is configured for monitoring the two sensors 20, and controlling the interface controller 50 to terminate the data transmission through one of the two connectors 10 on receiving the sensor signal generated by one of the two sensors 20 corresponding to the one of the two connectors 10.

The transmission control unit 30 includes a sensor control module 32, a monitoring module 34, and a termination module 36. The modules 32, 34, and 36 may execute one or more operations for the host 100. Additionally, the host 100 may comprise one or more specialized or general purpose processors, such as the processor 40 for executing the modules 32, 34, and 36.

The sensor control module 32 is configured for monitoring electrical connections of the two connectors 10, and for enabling one of the two sensors 20 to detect the desired object near the one of the two sensors 20 during existence of the electrical connection of one of the two connectors 10 corresponding to the one of the two sensors 20. For example, the sensor control module 32 detects voltage changes of the two connectors 10 to ascertain establishment, existence, or disconnection of the electrical connections.

The monitoring module 34 is configured for monitoring the sensors 20, on receiving the sensor signal generated by one or two of the two sensors 20, the monitor module 34 generates a termination command.

The termination module 36 is configured for controlling the interface controller 50 to terminate the data transmission through one or two of the two connectors 10 in response to the termination command.

The termination module 36 may further provide instructions to the operating system and/or other software applications of the host 100, thereby the host 100 outputs notification of the termination of the data transmission through the one or two of the connectors 10. Depending on the embodiments, notification of the termination of the data transmission may be accomplished by, but is not limited to, a text dialog box, audio and/or video notification.

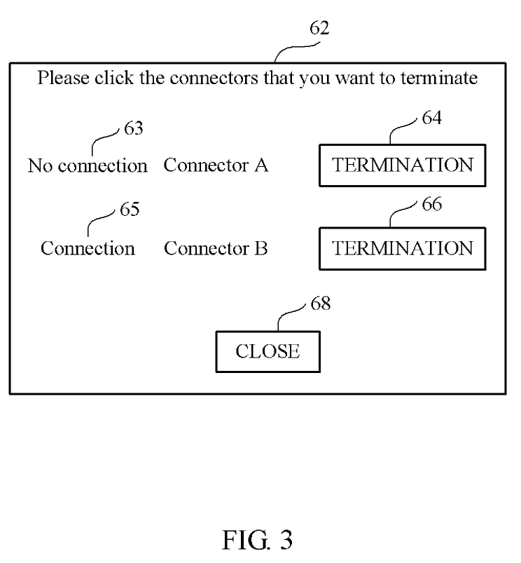

In an alternative embodiment, the host 100 includes only one sensor 20 for detecting a desired object near the two connectors 10. Accordingly, the monitoring module 34 is further configured for outputting a window 62 (shown in FIG. 3) on receiving a sensor signal generated by the sensor 20. The user can thus selects whether to terminate the data transmission or not to terminate. The window 62 shows icons of the two connectors 10, status marks 63, and functional buttons 64, 66 and 68. The status marks 63 denote electrical connection status (i.e., “connection” or “no connection”) of the two connectors 10. When the functional buttons 64 and 66 named “TERMINATION” are “clicked” or activated by the user, the data transmission of the two connectors 10 are terminated. The functional button 68 named “CLOSE” is used to close the window 62.

The termination module 36 is further configured for controlling the interface controller 50 to terminate the data transmission through one or two of the two connectors 10 in response to corresponding termination actions of the user in the window 62. For example, the termination actions may be such actions of the user clicking the “TERMINATION” buttons 64 and/or 66 when the user wants to terminate the data transmission through one or two of the two connectors 10, or the user clicking the “CLOSE” button 68 only when the sensor 20 is inadvertently activated.

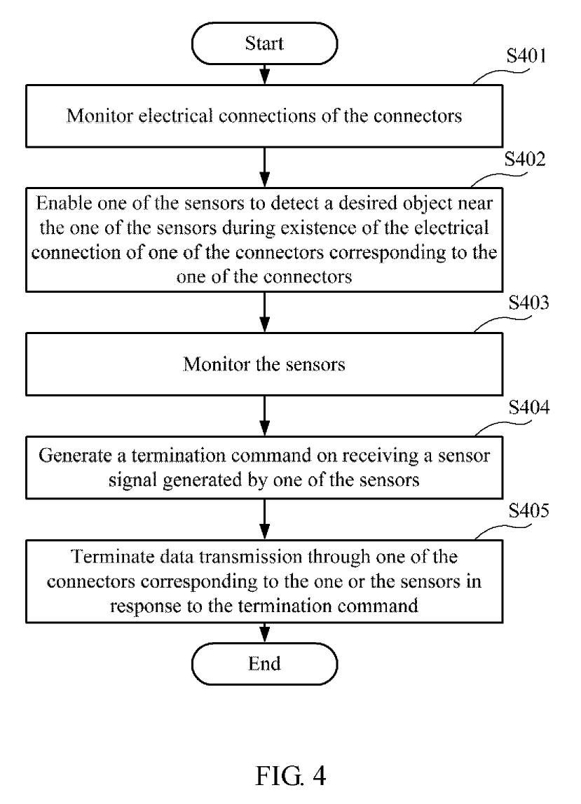

FIG. 4 is a flowchart of a first embodiment of a method for terminating the data transmission through the connectors 10. Additional steps may be added or deleted and steps may be executed in a different order than that described without deviating from the spirit of the disclosure.

In step S401, the sensor control module 32 monitors the electrical connections of the connectors 10. For example, the sensor control module 32 detects voltage changes of the connectors 10 to ascertain establishment, existence, or disconnection of the electrical connections.

In step S402, the sensor control module 32 further enables one of the sensors 20 to detect the desired object near the one of the sensors 20 during the existence of the electrical connection of one of the connectors 10 corresponding to the one of the sensors 20.

In step S403, the monitoring module 34 monitors the sensors 20.

In step S404, the monitoring module 34 generates a termination command on receiving a sensor signal generated by one of the sensors 20.

In step S405, the termination module 36 controls the interface controller 50 to terminate the data transmission through one of the connectors 10 corresponding to the one of the sensors 20 in response to the termination command.

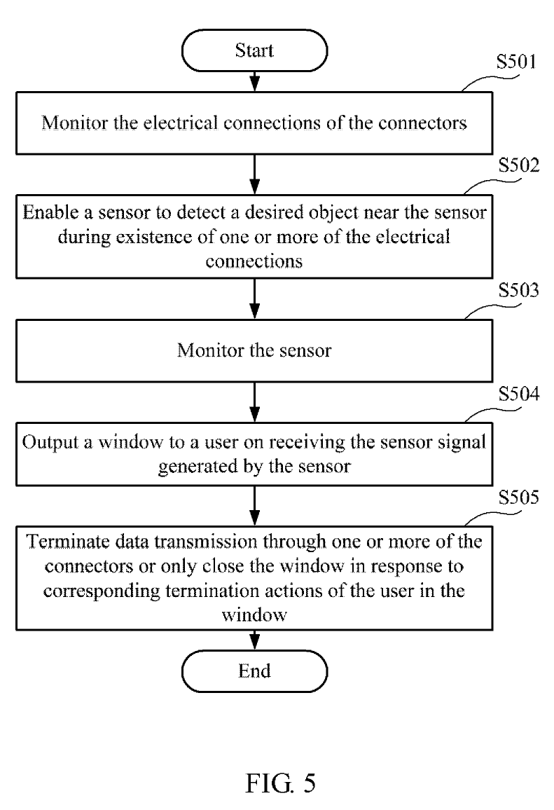

FIG. 5 is a flowchart of a second embodiment of a method for terminating the data transmission through the connectors 10. Additional steps may be added or deleted and steps may be executed in a different order than that described without deviating from the spirit of the disclosure.

In step S501, the sensor control module 32 monitors the electrical connections of the connectors 10.

In step S502, the sensor control module 32 further enables the sensor 20 to detect the desired object near the sensor 20 during the existence of one or more of the electrical connections.

In step S503, the monitoring module 34 monitors the sensor 20.

In step S504, on receiving the sensor signal generated by the sensor 20, the monitoring module 34 outputs the window 62 to the user. The user can thus selects whether to terminate the data transmission through one or more of the connectors 10 or not to terminate.

In step S505, the termination module 36 controls the interface controller 50 to terminate the data transmission through one or more of the connectors 10 or only closes the window 62 in response to corresponding termination actions of the user in the window 62. For example, the termination module 36 controls the interface controller 50 to terminate the data transmission through the connector “A” if the user clicks the “TERMINATION” button 66 in the window 62, and only closes the window 62, without terminating data transmission through the connectors 10, if the user clicks the “CLOSE” button 68 in the window 62.

Utilizing above mentioned method, the operating system of the host can be automatically alerted to terminate the data transmission through the connectors before the user attempts to detach the connectors. Thus, alerting the operating system is convenient and time saving, the user needs not to go through complicated predetermined process and/or needs not wait until the operating system finish other task. In addition, data loss or damage to the host or peripheral device can be prevented.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A host comprising:
one or more connectors mounted on the host;
an interface controller for controlling data transmission through the one or more connectors;
one or more sensors, each for detecting a desired object near one of the sensors, and generating a sensor signal when presence of the desired object is ascertained; and
a sensor control module configured for monitoring electrical connections of the one or more connectors, and enabling one of the sensors to detect the desired object near the one of the sensors during existence of one or more of the electrical connections;
a monitoring module configured for monitoring the sensors;
a termination module configured for controlling the interface controller to terminate the data transmission through one of the one or more connectors in response to the sensor signal generated by the corresponding to one of the one or more sensors; and
a processor executing the sensor control module, the monitoring module and the termination module.

2. The host in claim 1, wherein the sensor control module ascertains the existence of the electrical connections by detecting voltage changes of the one or more connectors.

3. The host in claim 1, wherein each of the one or more sensors is mounted adjacent to one of the one or more connectors.

4. A host comprising:
a housing;
one or more connectors mounted on the housing for being detachably connected to a peripheral device;
an interface controller for controlling data transmission through the one or more connectors;
a sensor mounted on the housing for detecting a desired object near the sensor, and generating a sensor signal when presence of the desired object is ascertained; and
a transmission control unit configured for monitoring the sensor, outputting a window in response to the sensor signal generated by the sensor, and controlling the interface controller to terminate the data transmission through the one or more connectors in response to a user input to the window.

5. The host in claim 4, wherein the transmission control unit is further configured for monitoring an electrical connection of each of the one or more connectors, and enabling the sensor to detect the desired object near the sensor during existence of one or more of the electrical connections.

6. The host in claim 4, wherein the transmission control unit is further configured for closing the window in response to the user input to the window.

7. The host in claim 6, wherein the window shows a functional button for each of the one or more connectors, the functional button is used to terminate the data transmission through the one or more connectors or to close the window.

8. The host in claim 4, wherein the transmission control unit comprises: a sensor control module configured for monitoring an electrical connection of each of the one or more connectors, and enabling the sensor to detect the desired object near the sensor during existence of one or more of the electrical connections;
a monitoring module configured for monitoring the sensor; and
a termination module configured for controlling the interface controller to terminate the data transmission through the one or more connectors on receiving the sensor signal generated by the sensor.

9. The host in claim 8, wherein the monitoring module is further configured for outputting the window to the user in response to the sensor signal generated by the sensor, the termination module is further configured for controlling the interface controller to terminate the data transmission through the one or more connectors in response to the user input to the window.

10. The host in claim 9, wherein the termination module is further configured for closing the window in response to the user input to the window.

11. The host in claim 8, wherein the sensor control module ascertains the existence of the electrical connections by detecting voltage changes of the one or more connectors.

12. A computer-implemented method for controlling data transmission through connectors mounted on a host, the method comprising:
detecting a desired object near the host;
generating a sensor signal when the desired object is detected;
outputting a window in response to the sensor signal; and
terminating the data transmission through one or more of the connectors in response to a user input to the window.

13. The method in claim 12, before the step of detecting the desired object, the method further comprising:
monitoring electrical connections of the connectors; and
enabling the detection of the desired object near the host during existence of one or more of the electrical connections.

14. The method in claim 13, the existence of one or more of the electrical connections is ascertained by detecting voltage changes of each of the connectors.

15. The method in claim 12, further comprising: closing the window in response to the user input to the window.

16. The method in claim 12, further comprising: outputting notification of the termination of the data transmission through the connectors.
